(19) United States
(12) Patent Application Publication
(10) Pub. No.: US 2018/0074490 A1
(43) Pub. Date: Mar. 15, 2018

(54) APPARATUS AND METHOD FOR VEHICLE REMOTE CONTROLLING AND REMOTE DRIVING SYSTEM

(71) Applicant: IPLAB INC., Seoul (KR)

(72) Inventor: Jun Hyun PARK, Gimpo-si (KR)

(21) Appl. No.: 15/694,770

(22) Filed: Sep. 2, 2017

(30) Foreign Application Priority Data
Sep. 12, 2016 (KR) 10-2016-0117504

(51) Int. Cl. G05D 1/00; G06Q 20/32; G06Q 20/24; G06Q 20/28; G07B 15/00

(52) U.S. Cl. CPC G05D 1/0038; G05D 1/0061; G05D 1/0016; G05D 1/005; H04L 67/12; G06Q 20/24; G06Q 20/28; G07B 15/00; G06Q 20/3224

(57) ABSTRACT

Disclosed is a vehicle remote control device and system, and a method for remote driving. The vehicle remote control system includes a remote driving vehicle transmitting driving information including images of a front, a rear, and sides, and path information of a vehicle, and vehicle condition information including a vehicle speed, an steering angle, front and rear pressure, a body tilt, an engine condition to a remote control platform, and receiving an ECU (Engine Control Unit) control signal from the remote control platform, thereby remotely running according to the control signal; and a vehicle remote control platform receiving the driving information from the remote driving vehicle, and remotely controlling the vehicle drive according to the received information.

### CROSS-REFERENCE TO RELATED APPLICATION

This application is based on and claims priority from Korean Patent Application No. 10-2016-0117504 filed on Sep. 12, 2016 in Korean Intellectual Property Office, the disclosure of which is incorporated by reference in its entirety.

### TECHNICAL FIELD

The present invention is related to a device and a method for controlling a vehicle, and specifically to a remote driving system for remotely controlling a vehicle drive.

### BACKGROUND

Unless otherwise indicated herein, contents set forth in this section are neither a prior art to the claims of the present application, nor construed as a prior art despite the inclusion in this section.

Several automotive companies are developing driverless autonomous driving vehicles. Competition arising from the Google's driverless car now gives rise to an expectation that we will be able to see an autonomous driving car on the road sooner than expected. However, in order for the autonomous driving cars to be commercialized, social norms, law, and cultural issues, as well as technological factors, must be resolved.

The driverless car is not able to run without problems technically in an environment with heavy rain, heavy snow, and heavy fog. When Google was licensed for the driverless car in Nevada, an inspector pointed out a problem of not being able to adapt to various weather conditions or an environment such as an unpaved road.

Another problem is that whether dozens of types of different autonomous cars can really run while smoothly communicating with each other. We, humans, drive while making decisions through various signals such as hand gestures, body gestures, or a face of another driver, or a ride feeling during the driving, but the autonomous driving cars cannot use these additional signals.

Another problem is related to a pedestrian. When the pedestrian suddenly jumps in or conducts the unexpected behaviors, the way people judge unconsciously may be substantially different from the way of determining the driving by an algorithm. It is not that there are always reasonable people on the road, but many obstacles or moving objects appear on the road.

In addition, problems related with licensing of the autonomous driving car, insurance, identifying the scope of responsibility, and identifying a responsible person in case of an accident have yet to be solved in the society. Will people psychologically accept the possibilities of accidents or death due to a car not driven by a person, who will make the law to allow this, or when is the law made? What social consensus will eventually allow the driverless cars to show up on the road? It is expected that it will take tens of years to proceed with social debate and agreement, an establishment of laws and jurisdictions, or the like, on all these matters. It is not an easy matter that the driverless autonomous driving cars run on our roads.

### SUMMARY OF THE DISCLOSURE

The present invention provides a remote vehicle control device and a remote driving system in which a chauffeur service driver drives a vehicle remotely to control driving of the vehicle in a control platform communicatively linked to the vehicle.

A remote driving vehicle according to one embodiment includes a sensor detecting driving data including image data of a front, a rear, and sides, vehicle location information and a travel path, and a safety speed on a road where a vehicle is being driven, which are necessary for driving a vehicle; a communication module transmitting the driving data transmitted from the sensor to a vehicle remote control device that remotely controls the vehicle and receiving a vehicle control signal from the remote control device; and a remote driving module receiving the vehicle control signal from the communication module and inputting the vehicle control signal to an ECU (Engine Control Unit) of the vehicle thereby controlling a driving device, a braking device, and a steering device of the vehicle, lighting devices provided in the vehicle, and auxiliary devices including a horn and wipers.

A vehicle remote control device according to another embodiment includes a communication module receiving picture data of a front, a rear, and sides, location and path data, and vehicle condition information from a vehicle, and transmitting a vehicle control signal for remotely driving the vehicle linked to the vehicle remote control device to the vehicle; a driving information output module outputting the picture data and the vehicle condition information received from the vehicle; and a remote control signal input module inputting the vehicle control signal for remotely driving the vehicle.

A method for remotely driving a vehicle according to another embodiment includes (A) sensing, in a sensor provided in the vehicle, driving information including image data of a front, a rear, and sides, vehicle location and travel path data, and safety speed information on a road where the vehicle is being driven, which are necessary for driving the vehicle; (B) transmitting, in a communication module, the driving information received from the sensor to a vehicle remote control platform for remotely controlling the vehicle; (C) receiving, in the communication module, a vehicle control signal from the remote control platform; and (D) remotely driving the vehicle, in a remote driving module, by receiving the vehicle control signal from the communication module and inputting the vehicle control signal in an ECU of the vehicle, thereby controlling driving, braking, and steering of the vehicle.

A method for driving a vehicle remote control device according to another embodiment includes receiving picture data of a front, a rear, and sides, location information, path information, and vehicle condition information from the vehicle; outputting the picture data and the vehicle condition information received from the vehicle; inputting a vehicle control signal for remotely controlling the vehicle; and transmitting the vehicle control signal inputted for remotely controlling the vehicle to the vehicle.

A vehicle remote control system according to another embodiment includes a remote driving vehicle transmitting driving information including images of a front, a rear, and sides, and path information of a vehicle, and vehicle condition information including a vehicle speed, a steering angle, front and rear pressure, a body tilt, an engine condition of the vehicle to a remote control platform, and receiving an ECU (Engine Control Unit) control signal from the remote control platform, thereby remotely being driven according to the control signal; and a vehicle remote control platform receiving the driving information from the remote driving vehicle, and remotely controlling driving of the vehicle according to received information.

Since the vehicle remote control device and the remote driving system as described above can perform a chauffeur service remotely without directly driving a car by its owner, it is possible to prevent an accident caused by the accumulation of fatigue due to a long time of driving, and it enables to utilize the time of driving more efficiently.

Further, when the present disclosure is applied to a transportation field such as a taxi, a bus, the chauffeur service, cargo transfer, etc., it is possible to control driving of the vehicle remotely, so that a chauffeur service driver does not need to move directly with the vehicle, and thus, efficiency of labor may be greatly increased.

In addition, when the remote driving system is applied to the taxi and the chauffeur service, it may not only create a crime prevention effect but also improve fuel efficiency and space utilization of the vehicle.

Further, it may eliminate drunken driving, drowsy driving, speeding, retaliatory driving, etc. The vehicle remote control device and the remote driving system according to the embodiments may have other effects besides the listed effects.

### BRIEF DESCRIPTION OF THE DRAWINGS

FIG. 1 is a view illustrating a vehicle remote control system configuration according to an embodiment.

FIG. 2 is a block diagram illustrating a schematic configuration of a remotely controlled vehicle according to an embodiment.

FIG. 3 is a block diagram illustrating a specific configuration of a remotely controlled vehicle 100 according to an embodiment.

FIG. 4 is a block diagram illustrating a schematic configuration of a vehicle remote control device of a remote control platform according to an embodiment.

FIG. 5A is a block diagram illustrating a more specific configuration of a vehicle remote control device according to an embodiment.

FIG. 5B is a view illustrating an example of hardware implementation of a vehicle remote control device according to an embodiment.

FIG. 6 is a view illustrating a signal flow of a vehicle remote control system according to an embodiment.

FIG. 7 is a flow chart illustrating a data processing flow for vehicle control after receiving a vehicle remote control signal according to an embodiment.

### DETAILED DESCRIPTION OF THE DISCLOSURE

Advantages and features of the present invention, and methods to accomplish the same, will become apparent with reference to embodiments described in detail below with reference to the accompanying drawings. However, the present invention is not limited to the embodiments described below but may be implemented in a variety of different forms. These embodiments are provided so that the disclosure of the present invention is complete and that those skilled in the art will fully understand the scope of the present invention, and the present invention is only defined by the scope of the claims. Like reference numerals refer to like elements throughout the specification.

In describing the embodiments of the present invention, a detailed description of known functions and configurations will be omitted when it may make the subject matter of the present invention unnecessarily unclear. The following terms are defined in consideration of the functions in the embodiments of the present invention, which may vary depending on a user, intention of an operator, a custom, and the like. Therefore, the definition should be based on contents throughout this specification.

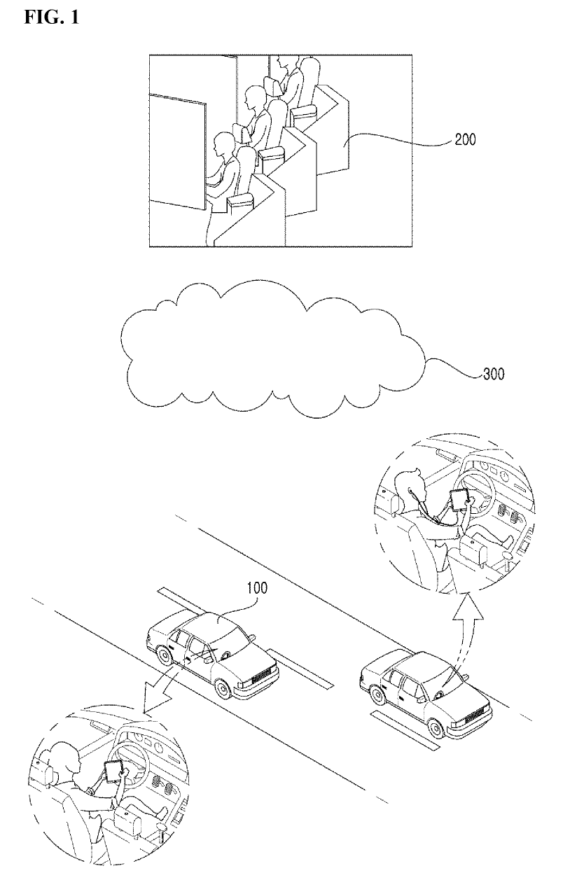

FIG. 1 is a view illustrating a vehicle remote control system configuration according to an embodiment.

Referring to FIG. 1, a vehicle remote control system may be configured to include a remotely controlled vehicle 100, a vehicle remote control device 200 of a remote control platform, and a communication path 300.

The vehicle remote control system according to an embodiment communicatively links the vehicle 100 with the remote control device 200, thereby allowing a chauffeur service driver to drive the vehicle 100 remotely with the remote control device 200. With the vehicle remote control system, drivers link their vehicles 100 to the remote control devices 200 in case of feeling sudden tiredness, drunk, or an emergency, and make their vehicles to be remotely controlled, so that the drivers may utilize their driving time more efficiently, because it is possible to make their vehicles to drive without the drivers' driving in case of commute driving and long distance driving.

A remote control platform according to an embodiment may include at least one vehicle control device 200 and a management server (not shown). The vehicle remote control device 200 remotely drives a linked vehicle, and the management server monitors matching of the vehicle and the vehicle remote control device, communication conditions, and operation time of each vehicle remote control device, etc. In addition, the management server monitors driving conditions of many remote chauffeur service drivers who control the vehicle remote control device. For example, when the remote chauffeur service drivers violate preset safety operation regulations such as a speed violation, a signal violation, sudden starting, sudden braking, etc. while driving remotely, the management server may detect a violation of the remote chauffeur service driver, notify a manager of the server (a supervisor) of the violation, and transmit an alarm notification to a chauffeur service driver who violates the safety operation regulations. When the chauffeur service drivers violate the safety operation regulations, the management server may manage the chauffeur service drivers by collecting penalties according to each violation by each of the chauffeur service drivers.

The communication path 300 may be various networks that communicatively link the vehicle 100 and the vehicle remote control device 200. For example, the communication path 300 may include wireless communication, wired communication, optical, ultrasound, or a combination thereof. An example of wireless communication that may be included in the communication path 300 may include satellite communication, cellular communication, Bluetooth, wireless HDMI (high-definition multimedia interface), NFC (Near Field Communication), IrDA (Infrared Data Association standard), WiFi (wireless fidelity), WiMAX (worldwide interoperability for microwave access), and LTE. The communication path 300 may also traverse multiple network topologies and distances. For example, the communication path 300 may include a direct connection, a PAN (personal area network), a LAN (local area network), a MAN (metropolitan area network), a WAN (wide area network), or any combination thereof.

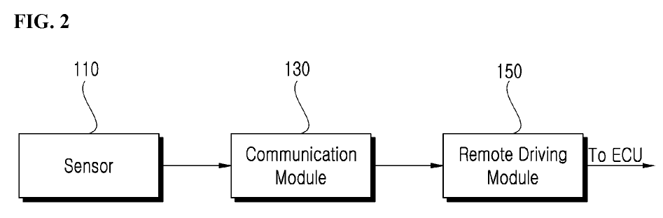

FIG. 2 is a block diagram illustrating a schematic configuration of a remotely controlled vehicle according to an embodiment.

Referring to FIG. 2, the remotely controlled vehicle 100 may comprise a sensor 110, a communication module 130, and a remote driving module 150. The term ‘module,’ as used herein, should be interpreted to include software, hardware, or a combination thereof, depending on the context in which the term is used. For example, the software may be machine language, firmware, embedded code, and application software. As another example, the hardware may be a circuit, a processor, a computer, an integrated circuit, an integrated circuit core, a sensor, a MEMS (Micro-Electro-Mechanical System), a passive device, or a combination thereof.

The sensor 110 is provided on a front, a rear, and sides of the vehicle, and inside a vehicle body, and senses driving data required for driving and vehicle condition information. The driving data may include image data of a front, a rear, and sides, vehicle location information and travel path information, and safety speed information on a road in which the vehicle is being driven, which are necessary for driving the vehicle.

The communication module 130 transmits the driving data and the vehicle condition information received from the sensor 110 provided in the vehicle 100 to a vehicle remote control platform, and receives a vehicle control signal from the remote control platform.

The remote driving module 150 receives the vehicle control signal transmitted from the remote control platform 200 in the communication module 130, and inputs the control signal to an ECU (Engine Control Unit) of the vehicle. Driving, braking and steering of the vehicle are controlled by the control signal input to the ECU so that the vehicle can be driven by remote control.

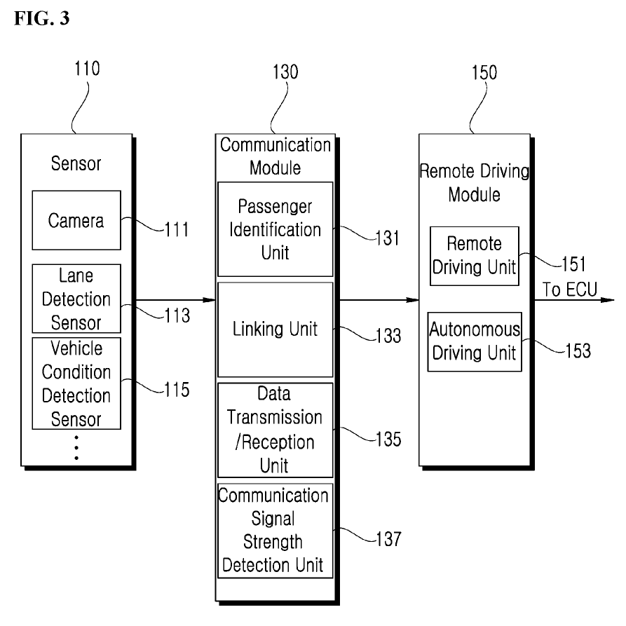

FIG. 3 is a block diagram illustrating a specific configuration of a remotely controlled vehicle 100 according to an embodiment.

Referring to FIG. 3, the sensor 110 may include a camera 111, a lane detection sensor 113, a vehicle condition detection sensor 115, etc., which sense driving information and condition information of the vehicle and a series of information required for driving the vehicle. The communication module 130 may include a passenger identification unit 131, a linking unit 133, a data transmission/reception unit 135, and a communication signal strength detection unit 135. The remote driving module 150 may include a remote driving unit 151 and an autonomous driving unit 153.

The camera 111, which is one of the sensors 110 provided in the vehicle, captures pictures of the front, the rear, and the sides of the vehicle. The lane detection sensor 113 recognizes a lane and detects a departure from the lane.

The vehicle condition detection sensor 115 detects various vehicle conditions including a steering angle of the vehicle, engine and battery conditions (a battery level and a battery temperature), engine temperature, a remaining amount of fuel, a distance capable of driving, a fault warning light, a turn signal, flashing condition of an emergency light, temperatures inside and outside of the vehicle, a left and right wheel speed, a vehicle tilt, etc. The sensor 110 provided in the vehicle for sensing the driving information and the vehicle condition data is not limited to sensors as described above.

The passenger identification unit 131 of the communication module 130 verifies an identity of a passenger when the passenger attempts to remotely control his or her vehicle after boarding the vehicle. For example, whether the passenger is a registered owner of the vehicle may be verified by means of biometric information such as fingerprints, irises, voices, etc., password recognition or the like.

The linking unit 133 is communicatively linked with a specific control device of the remote control platform for the remote control of the vehicle when identification of a vehicle passenger is verified.

The data transmission/reception unit 135, after communicatively linked, transmits the driving data and the vehicle condition information sensed in the vehicle to the vehicle remote control device 200, and receives the vehicle control signal from the vehicle remote control device 200.

In an embodiment, the data transmission/reception unit 135 enables communication between the vehicle passenger and a remote chauffeur service driver after the vehicle and the vehicle remote control device are communicatively linked. In addition, the data transmission/reception unit 135 may communicate with the manager (supervisor) of the management server if the vehicle passenger wants to change the remote chauffeur service driver due to the violation of traffic laws, unfaithfulness and the like, or to stop a chauffeur service. In this case, the remote chauffeur service driver is excluded from communication between the manager and the vehicle passenger, so the passenger may file complaints (for example, violations of traffic laws, non-use of the shortest path, etc.) or request substitution of the remote chauffeur service driver. In an embodiment, the data transmission/reception unit 135 connecting the passenger with the remote chauffeur service driver or the server manager (supervisor) may be mounted on an audio device of the vehicle in the form of a button or mounted on a seat head rest, thereby also allowing the vehicle passenger to communicate with the manager (supervisor) and the remote chauffeur service driver in a back seat.

The communication signal strength detection unit 137 detects communication signal strength between the vehicle 100 and the vehicle remote control device 200. In an embodiment, the communication signal strength detection unit 137 may issue an emergency notification to the vehicle passenger, the remote chauffeur service driver, and the remote control platform when the communication signal strength between the vehicle 100 and the vehicle remote control device 200 is less than a predetermined level.

The remote driving unit 151 of the remote driving module 150 inputs the vehicle control signal received from the control device to the ECU for driving remotely when the signal strength is higher than the predetermined level in communicating with the remote control device 200.

When the communication signal strength is less than the predetermined level in communicating with the remote control device, the autonomous driving unit (153) issues an alarm on the communication signal strength to the vehicle passenger and the remote control platform, and controls the vehicle in an autonomous driving mode, or moves and stops the vehicle with urgency to the nearest safety zone via a remote control by the chauffeur service driver under communication caution condition where the communication signal strength is less than the predetermined level. If communication between the vehicle and the remote control device is completely lost, it makes the vehicle to be driven autonomously and stopped at the nearest safety zone.

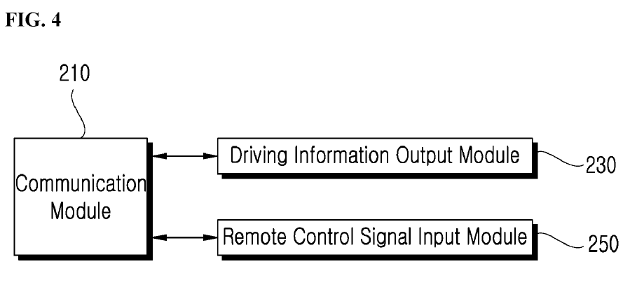

FIG. 4 is a block diagram illustrating a schematic configuration of a vehicle remote control device of a remote control platform according to an embodiment.

Referring to FIG. 4, the vehicle remote control device 200 may include a communication module 210, a driving information output module 230, and a remote control signal input module 250.

The communication module 210 receives the picture data of the front, the rear, and the sides of the vehicle, the location information, the path information, and the vehicle condition information transmitted from a linked vehicle, and transmits the vehicle control signal for remotely driving the vehicle to the linked vehicle 100.

The driving information output module 230 outputs the driving data received from the vehicle 100 for remote control. For example, the driving information output module 230 outputs images of the front, the rear, and the sides of the vehicle, the vehicle condition information, acoustic information collected around the vehicle, etc. through an output device such as a screen or a speaker. The remote control signal input module 250 inputs the vehicle control signal for remotely driving the vehicle.

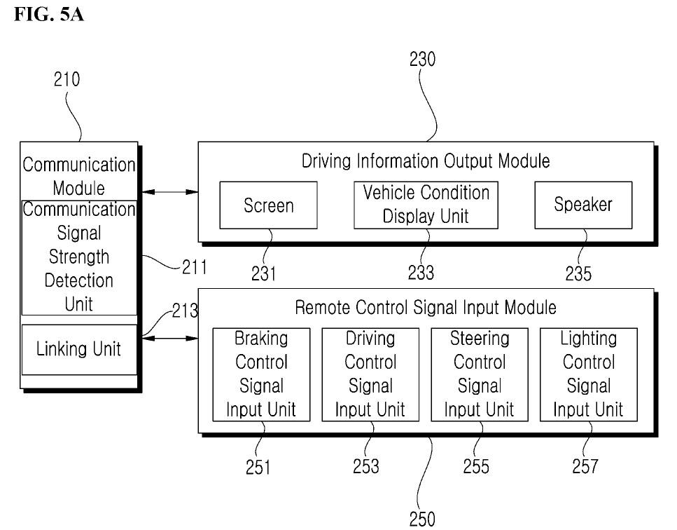

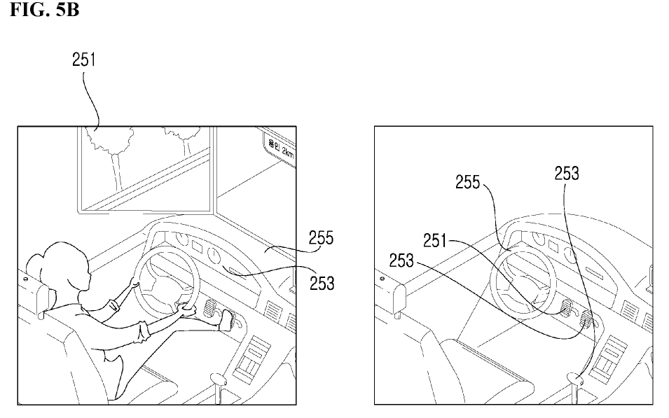

FIG. 5A is a block diagram illustrating a more specific configuration of a vehicle remote control device according to an embodiment, and FIG. 5B is a view illustrating an example of hardware implementation of a vehicle remote control device according to an embodiment. To facilitate understanding, FIGS. 5A and 5B will be described together.

Referring to FIG. 5A, the communication module 210 of the vehicle remote control device 200 includes a communication signal strength detection unit 211 and a linking unit 213. The driving information output module 230 may include a screen 231, a vehicle condition display unit 233, and a speaker 235. The remote control signal input module 250 may include a braking control signal input 251, a driving control signal input unit 253, a steering control signal input unit 255, and a lighting control signal input unit 257.

The communication signal strength detection unit 211 of the communication module 210 detects the communication signal strength between the remotely controlled vehicle 100 and the vehicle remote control device 200.

The linking unit 213 performs a communication link between the vehicle and the vehicle remote control device when identification of the chauffeur service driver who remotely drives the vehicle is completed. At this time, the linking unit 213 may verify the identity of the chauffeur service driver via previously registered biometric information and password authentication. According to an embodiment, at the identification phase of the remote chauffeur service driver, the linking unit 213 may notify the remote chauffeur service driver of legal liability and assurance of specific insurance in case of an accident, and may approve the remote control of the vehicle when the chauffeur service driver agrees to the notification. Specifically, once driving qualification including a driver's license, a taxi license, a truck license, etc. of the remote chauffeur service driver is authenticated, it is notified to the remote chauffeur service driver of contents for the legal liability of the remote driver in the event of the accident, and warranties and limitations according to insured products of the remote chauffeur service driver and an owner of the vehicle. Then, the linking unit 213 may link the vehicle and the remote control device so that the remote chauffeur service driver may remotely control the vehicle when the remote chauffeur service driver grasps the contents of the notification and electronically agrees to it.

The screen 231 of the driving information output module 230 displays images of the front, the rear, and sides received from the vehicle linked to the vehicle remote control device. As shown in FIG. 5B, a screen 251 is provided on a front and sides of the chauffeur service driver who remotely controls the vehicle, and provides pictures of the front, the rear, and the sides sensed by the vehicle to the remote chauffeur service driver.

The vehicle condition display unit 233 displays the vehicle condition information including the speed of the remotely controlled vehicle, the steering angle of the vehicle, the engine and battery conditions, the remaining amount of fuel and/or amount of battery power, the distance capable of driving, operating condition of a light device of the vehicle, a turn signal condition, the temperatures inside and outside of the vehicle, wheel pressure, a tilt, the location information, etc. According to an embodiment, the vehicle condition display unit 233 may be implemented as a screen, or may be implemented as a dashboard 253 provided in a general vehicle as shown in FIG. 5B. The speaker 235 outputs sound sensed around the vehicle.

Each component of the driving information output module 230 receives and outputs information sensed by a sensor provided in the vehicle, thereby providing the chauffeur service driver who remotely controls the vehicle with information required for vehicle remote driving in real time, and thus, allowing the remote chauffeur service driver to remotely control the vehicle through output information.

The braking control signal input unit 251 of the remote control signal input module 250 inputs the braking control signal of the vehicle. The braking control signal input unit 251 may be implemented as a brake 251 for controlling vehicle braking, as shown in FIG. 5B.

The driving control signal input unit 253 inputs a vehicle driving control signal. The driving control signal input unit 253 may be embodied as an accelerator and a gear 253 for controlling driving of the vehicle, as shown in FIG. 5B.

The steering control signal input unit 255 receives input of a steering control signal of the vehicle. The steering control signal input unit 255 may be provided as a steering wheel on the remote vehicle control device, as shown in FIG. 5B, to remotely control steering of the vehicle.

The vehicle lighting control signal input unit 257 receives input of a control signal for adjusting driving and brightness of a lighting device mounted on the vehicle including a turn signal, a headlight, a traffic light, a fog light, and an emergency light.

In addition, the remote control signal input module 250 may also receive input of a control signal of an auxiliary device including wiper, a horn, and the like of the vehicle.

In an embodiment, the chauffeur service driver who remotely driverless the vehicle may remotely drive the vehicle linked with the vehicle remote control device by means of a wheel, a gear, a brake, or an accelerator provided in the vehicle remote control device.

According to an embodiment, the vehicle remote control platform may include a plurality of vehicle remote control devices. Since each remote control device is monitored by the management system, it is possible to change the remote control device that is linked to a specific vehicle through communication between the vehicle remote control devices when the chauffeur service driver needs to be changed during remote control of the vehicle. As a result, the remote chauffeur service drivers may take a break or have a time for personal matters during the remote control without affecting driving of the linked vehicle.

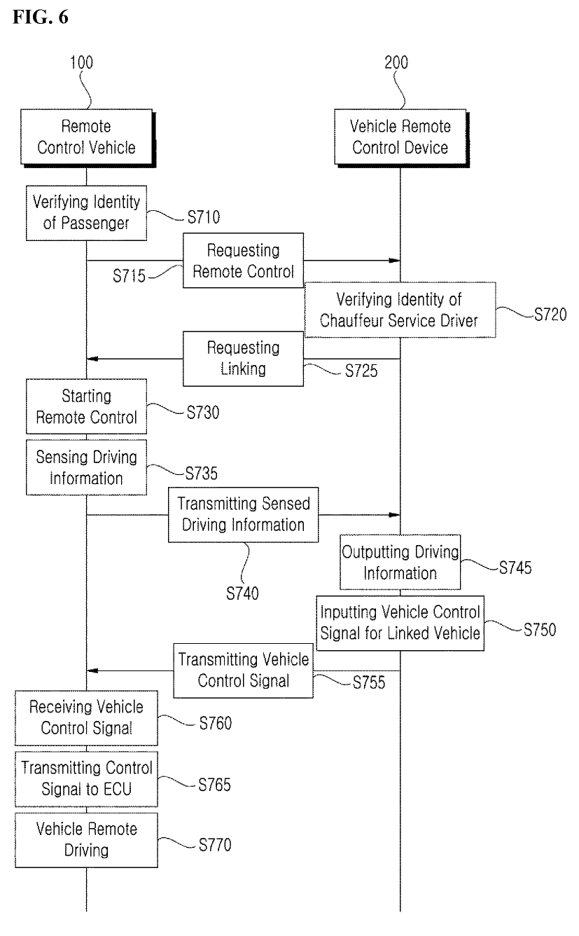

Hereinafter, a vehicle remote driving method will be described in turn. Since effects (functions) of the vehicle remote control method according to the present invention are essentially the same as that of the vehicle remote control device and the vehicle remote control system, a description overlapping with FIGS. 1 to 5B will be omitted. FIG. 6 is a view illustrating a signal flow of a vehicle remote control system according to an embodiment.

In step S710, the vehicle 100 verifies the identity of the passenger. Identification is a process of verifying whether the passenger is a registered passenger or a car owner himself/herself, and may be performed via biometric information authentication, password input, electronic device authentication, and the like. When the identification of the passenger is normally completed, in step S715, the vehicle 100 transmits a remote control request signal to the vehicle remote controller 200.

In an embodiment, a payment process for the remote chauffeur service may be performed after the remote control request. For example, when a destination is determined, a chauffeur service time and a driving distance are determined from a current location to the destination, so that a service fare corresponding to a remote chauffeur service time and the driving distance may be pre-paid as a payment means such as a credit card and the like. If the chauffeur service time or the driving distance is not fixed and the fare for the remote chauffeur service has not been determined, one may pay an additional amount in the destination after pre-paying a certain amount, or may refund an excess amount when pre-paying more.

In step S720, when the vehicle remote control device 200 receives the remote control request signal, it performs a process of verifying the identity of the chauffeur service driver who drives the vehicle remotely. In this process, the identity of the remote chauffeur service driver may be verified by biometric authentication, personal information input, device authentication, and password input of the chauffeur service driver. At the identification phase of the remote chauffeur service driver according to an embodiment, it is possible to notify the remote chauffeur service driver of contents of legal liability and assurance of specific insurance in case of an accident, and to approve the remote control of the vehicle when the chauffeur service driver agrees to the notification. Specifically, once driving qualification including a driver's license, a taxi license, a truck license, etc. of the remote chauffeur service driver is authenticated, it is notified to the remote chauffeur service driver of contents for the legal liability of the remote driver in the event of the accident, and warranties and limitations according to insured products of the remote chauffeur service driver and an owner of the vehicle. Then, it is possible to link the vehicle and the remote control device so that the remote chauffeur service driver may remotely control the vehicle when the remote chauffeur service driver grasps the contents of the notification and electronically agrees to it.

In step S725, when the identity of the remote chauffeur service driver is verified, communication linking with the vehicle 100 is performed.

In step S730, the vehicle remote control is started after the linking.

In step S735, for the remote control of the vehicle, a plurality of sensors mounted on the vehicle perform a process of sensing driving data, such as the images of the front and rear, and vehicle condition information required for driving the vehicle.

In step S740, the sensed data and vehicle condition information required for driving are transmitted to a vehicle remote governing device 200.

In step S745, the vehicle remote control device 200 outputs the driving data and the vehicle condition information received from the vehicle 100 linked thereto. In step S750, the vehicle control signal is input so as to drive the vehicle based on the outputted information.

In step S755, the vehicle control signal is transmitted to the vehicle 100, and in step S760, the vehicle 100 receives the vehicle control signal. Then, in step S765, the received vehicle control signal is transmitted to the ECU so that the vehicle can be remotely driven, in step S770, by the vehicle control signal input to the ECU.

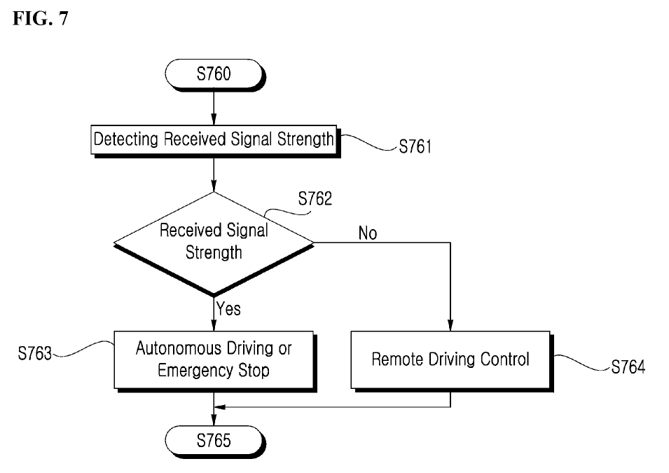

FIG. 7 is a flow chart illustrating a data processing flow for vehicle control after receiving a vehicle remote control signal according to an embodiment.

Upon receiving the vehicle control signal from the vehicle, in step S761, the strength of received signal is detected. In step S762, it is determined whether the received signal strength which was detected is less than a specific value. If the received signal strength is less than the specific value, the process proceeds to step S763 to allow the vehicle to perform autonomous driving or to make the vehicle to stop on a safe road. If the received control signal strength is greater than or equal to the specific value, the process proceeds to step S764 to control the vehicle remotely through the control signal.

Since the vehicle remote control device and the remote driving system as described above can perform a chauffeur service remotely without directly driving a car by its owner, it is possible to prevent an accident caused by accumulation of fatigue due to a long time of driving, and it makes many people utilize time of driving more efficiently.

Further, when the present disclosure is applied to a transportation field such as a taxi, a bus, the chauffeur service, cargo transfer, etc., it is possible to control driving of the vehicle remotely, so that a chauffeur service driver does not need to move directly with the vehicle, and thus, efficiency of labor may be greatly increased.

In addition, when the remote driving system is applied to the taxi and the chauffeur service, it may not only create a crime prevention effect but also improve fuel efficiency and space utilization of the vehicle. Further, it may eliminate drunken driving, sleepy driving, speeding, retaliatory driving, and the like.

The disclosed contents are illustrative only, and it could be modified and performed in a variety of ways by one of ordinary skill in the art without departing from the teaching defined in the claims, and thus, the scope of protection of the disclosed contents is not limited to the specific embodiments described above.

What is claimed is:

1. A remote driving vehicle comprising:
a sensor detecting driving data including image data of a front, a rear, and sides, vehicle location information and a travel path, and a safety speed on a road where the vehicle is driven, which are necessary for driving the vehicle;
a communication module transmitting the driving data received from the sensor to a vehicle remote control device that remotely controls the vehicle and receiving a vehicle control signal from the remote control device; and
a remote driving module receiving the vehicle control signal from the communication module and inputting the vehicle control signal to an ECU (Engine Control Unit) of the vehicle, thereby controlling a driving device, a braking device, and a steering device of the vehicle, lighting devices provided in the vehicle, and auxiliary devices including a horn and wipers,
wherein the remote driving module comprises:
a remote driving unit inputting a remote signal received from a vehicle remote control device into the ECU to perform remote driving of the vehicle when communication signal strength between the vehicle and the remote control device is greater than or equal to a predetermined value; and
an autonomous driving unit enabling the vehicle to autonomously drive or stop on a temporary road when the communication signal strength is less than the predetermined value,
wherein the communication module monitors driving conditions of the vehicle which is remotely controlled and transmits driving regulation violation information to a remote driving management server when the remote driving occurs in violation of safe driving regulations including a speed violation, a signal violation, sudden starting, and sudden braking during the remote driving.

2. The remote driving vehicle of claim 1, wherein the sensor comprises:
a camera capturing images of a front, a rear, and sides of the vehicle;
a lane detection sensor detecting a driving lane of the vehicle and a departure from the lane; and
a vehicle condition detection sensor detecting vehicle conditions including a steering angle of the vehicle, a vehicle speed, a left and right wheel speed, wheel pressure, and a vehicle tilt.

3. The remote driving vehicle of claim 1, wherein the communication module comprises:
a passenger identification unit verifying an identity of a vehicle passenger through biometric information including an iris and fingerprints, or through an authentication code including a password and device information; and
a communication signal strength detection unit detecting a signal strength of communication data including the vehicle control signal received from the vehicle remote control device that remotely controls the vehicle and the driving data transmitted from the vehicle; and
a linking unit communicatively linking the vehicle with the vehicle remote control device.

4. A vehicle remote control device comprising:
a communication module receiving picture data of a front, a rear, and sides of a vehicle, location and path data, and vehicle condition information from the vehicle and transmitting a vehicle control signal for remotely driving the vehicle linked to the vehicle remote control device to the vehicle;
a driving information output module outputting the picture data and the vehicle condition information received from the vehicle; and
a remote control signal input module inputting the vehicle control signal for remotely driving the vehicle,
wherein the driving information output module comprises:
a screen displaying pictures of a front, a rear, and sides of the vehicle received from the vehicle;
a vehicle condition information display unit displaying the vehicle condition information including a vehicle speed, a steering angle of the vehicle, engine and battery conditions, a remaining amount of fuel, battery power, a wheel condition, an engine condition, and a tire condition; and
a speaker outputting acoustic information transmitted from the vehicle,
wherein the remote control signal input module comprises:
a braking control signal input unit controlling the vehicle to decelerate;
a driving control signal input unit controlling driving of the vehicle; and
a steering control signal input unit controlling steering of the vehicle,
wherein the communication module displays an alarm notification when receiving a signal of safe-driving regulation violations including a speed violation, a signal violation, sudden starting, and sudden braking from the vehicle.

5. The vehicle remote control device of claim 4, wherein the communication module comprises:
a communication signal strength detection unit detecting a communication signal strength of the vehicle; and
a linking unit linking with the vehicle after recognizing an identity of a remote chauffeur service driver by recognizing a biometric signal or an authentication code of the remote chauffeur service driver who remotely controls the vehicle,
wherein the linking unit, after recognizing the identity of the remote chauffeur service driver, notifies in advance the remote chauffeur service driver of legal liability of the remote chauffeur service driver and warranties and limitations according to insured products of the remote chauffeur service driver and an owner of the vehicle, when driving qualification including a driver's license, a taxi license, or a truck license is authenticated, and links the remote control device with the vehicle when the remote chauffeur service driver agrees to the notified contents.

6. A method for remotely driving a vehicle comprising:
(A) sensing, in a sensor provided in a vehicle, driving information including image data of a front, a rear, and sides, vehicle location and travel path data, and safety speed information on a road in which the vehicle is driven, which are necessary for driving the vehicle;
(B) transmitting, in a communication module, the driving information received from the sensor to a vehicle remote control platform for remotely controlling the vehicle;
(C) receiving, in the communication module, a vehicle control signal from the remote control platform; and
(D) remotely driving the vehicle, in a remote driving module, by receiving the vehicle control signal from the communication module and inputting the vehicle control signal into an ECU of the vehicle, thereby controlling driving, braking and steering of the vehicle,
wherein the remote driving (D) of the vehicle comprises:
issuing an emergency alarm for communication conditions to a vehicle passenger and the remote control platform if a signal strength is below a predetermined level when communicating with the remote control platform;
controlling the vehicle in an autonomous driving mode or stopping the vehicle on an auxiliary road, after issuing the emergency alarm, and stopping the vehicle in a safety zone by autonomously driving when the communication is disconnected; and
transmitting operation regulation violation information to a remote driving management server when a remote driving occurs in violation of safe driving regulations, including a speed violation, a signal violation, sudden starting, and sudden braking during the remote driving, by monitoring driving conditions of the vehicle controlled remotely.

7. The method of claim 6, wherein the sensing (A) of the driving information comprises obtaining pictures of a front, a rear, and sides of the vehicle by a camera provided in the vehicle, detecting a driving lane of the vehicle and a departure from the lane by a lane detection sensor, and detecting vehicle condition information including a vehicle speed, a steering angle of the vehicle, engine and battery conditions, a remaining amount of fuel, battery power, a left and right wheel speed, wheel pressure, and a vehicle tilt.

8. The method of claim 6, wherein the remote driving (D) of the vehicle comprises:
verifying an identity of a vehicle passenger by verifying biometrics or an authentication code;
inputting, after verifying the identity of a passenger, a destination and paying a fare for a remote chauffeur service using a payment means including a credit card depending on a distance between the entered destination and departure location and anticipated time for the remote chauffeur service, or pre-paying a certain amount if the destination is not determined;
detecting, after the payment process, a communication signal strength of communication data including a vehicle control signal received from a vehicle remote control platform that remotely controls the vehicle and driving information transmitted from the vehicle;
performing remote driving of the vehicle by inputting a remote signal received from the vehicle remote control platform into an ECU of the vehicle when the communication signal strength is equal to or greater than a predetermined value; and
allowing the vehicle to autonomously drive or stop on a temporary road when the communication signal strength is less than the predetermined value.

9. A method for driving a vehicle remote control device, the method comprising:
receiving picture data of a front, a rear, and sides, location information, path information, and vehicle condition information from a vehicle;
outputting the picture data and the vehicle condition information received from the vehicle;
inputting a vehicle control signal for remotely controlling the vehicle; and
transmitting the vehicle control signal inputted for remote driving of the vehicle to the vehicle,
wherein the outputting outputs the picture data of a front, a rear, and sides of the vehicle, the vehicle condition information, acoustic information received from the vehicle, and an alarm notification when receiving a signal for safe driving regulation violations from the vehicle, including a speed violation, a signal violation, sudden starting, and sudden braking,
wherein the inputting inputs a braking control signal controlling the vehicle to decelerate, a driving control signal controlling driving of the vehicle, and a steering control signal controlling steering of the vehicle.

10. The method of claim 9, wherein the receiving of the vehicle condition information comprises:
detecting a communication signal strength of the vehicle;
linking with the vehicle after recognizing an identity of a remote chauffeur service driver by recognizing biometric information or an authentication code of the remote chauffeur service driver who remotely controls the vehicle; and
notifying in advance, after recognizing the identity of the remote chauffeur service driver, the remote chauffeur service driver of legal liability of the remote driver and warranties and limitations according to insured products of the remote chauffeur service driver and an owner of the vehicle, when driving qualification including a driver's license, a taxi license, and a truck license is authenticated, and linking the remote control device with the vehicle when the remote chauffeur service driver agrees to the notified contents.

11. A vehicle remote control system comprising:
a remote driving vehicle transmitting driving information including images of a front, a rear, and sides, and path information of a vehicle, and vehicle condition information including a vehicle speed, an steering angle, front and rear pressure, a body tilt, an engine condition to a remote control platform, and receiving an ECU (Engine Control Unit) control signal from the remote control platform, thereby remotely operating according to the control signal; and
a vehicle remote control platform receiving the driving information from the remote driving vehicle and remotely controlling driving of the vehicle according to the received information,
wherein the vehicle remote control platform comprises:
at least one remote driving device linked with a specific vehicle and controlling the linked vehicle; and
a management server monitoring linking and communication conditions of the remote driving device and the vehicle,
wherein the remote driving device comprises:
an image display screen displaying pictures of a front, a rear and sides received from the vehicle
a vehicle condition information display screen displaying vehicle condition information transmitted from the vehicle controlled remotely;
a seat on which a remote chauffeur service driver is boarding;
a control signal input module controlling a brake, an accelerator, a gear, a steering wheel for remotely controlling driving, braking and steering of the vehicle, vehicle lighting devices including a headlight, a high beam and a sidelight, and vehicle auxiliary devices including wipers and a horn; and
a communication module configured to be linked with a remote control vehicle after recognizing an identity of a remote chauffeur service driver, receive driving information from the vehicle, and transmit remote control information for controlling the vehicle.
